(19) United States
(12) Patent Application Publication
(10) Pub. No.: US 2018/0116130 A1
(43) Pub. Date: May 3, 2018

(54) IMPROVEMENTS IN OR RELATING TO PLANTERS

(71) Applicant: Terence William Michael MARTIN, Rugeley (GB)

(72) Inventor: Terence William Michael Martin, Rugeley (GB)

(21) Appl. No.: 15/561,950

(22) PCT Filed: Feb. 18, 2016
(86) PCT No.: PCT/GB2016/050405

§ 371 Date: Sep. 26, 2017

(30) Foreign Application Priority Data
Mar. 26, 2015 (GB) 1505220.2

(51) Int. Cl. A01G 9/12

(52) U.S. Cl. CPC A01G 9/12

(57) ABSTRACT

A planter 10 which defines a planting recess 12 for receiving a plant, in use, and which also defines a ballast cavity 14 for receiving ballast, in use, to provide stability for the planter 10.

The present invention relates to planters and improvements thereto.

It is common practice to grow plants in plant pots, for various reasons. In particular, the potted plant can easily be moved to an alternative location. Many plant pots taper from a relatively wide mouth at their top, to a relatively narrow base. This can make the plant pot unstable, particularly if it contains a large plant, or a plant which has grown unevenly in different directions.

Examples of the present invention provide a planter which defines a planting recess for receiving a plant, in use, and a ballast cavity for receiving ballast, in use, to provide stability for the planter.

The planter may comprise a main part which defines the recess and the cavity. The planter may further comprise a closure which cooperates, in use, to retain ballast in the ballast cavity. The closure may be removable for introducing or removing ballast. The closure may be a generally planar member which, in use, forms a base of the planter.

The ballast cavity may extend around the perimeter of the planting recess. The cavity may extend continuously around the entire perimeter.

When the planter is in use with the planting recess open from above, the cavity may widen toward its base. When the planter is in use with the planting recess open from above, the planting recess may widen upwardly towards its mouth. The planting recess may be generally an inverted frusto-conical space. The cavity may be provided between the planting recess and an external, non-inverted, frusto-conical wall.

The main part may provide a continuous wall which divides the recess and the cavity. The main part may be a moulded part. The main part may be formed to stack, in nested manner, with another main part, when the recess and cavity are empty.

The planter may define a plurality of planting recesses and/or a plurality of ballast cavities.

Examples of the present invention will now be described in more detail, by way of example only, and with reference to the accompanying drawings, in which:

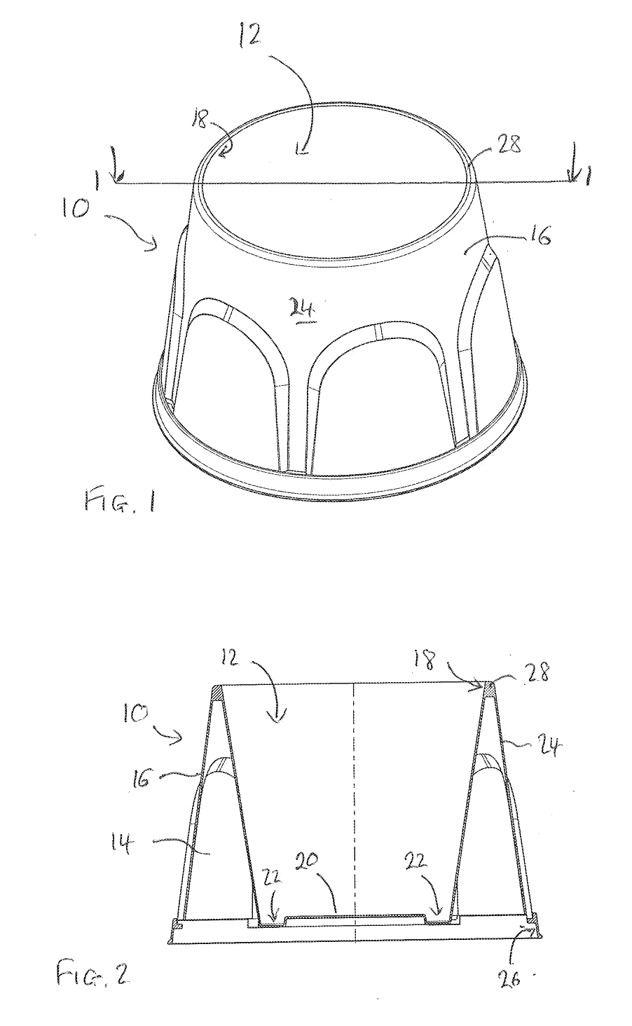

FIG. 1 is a perspective view of an example planter in accordance with one embodiment of the invention;

FIG. 2 is a vertical cross-section through the main part of the planter of FIG. 1, along the line 1-1 in FIG. 1;

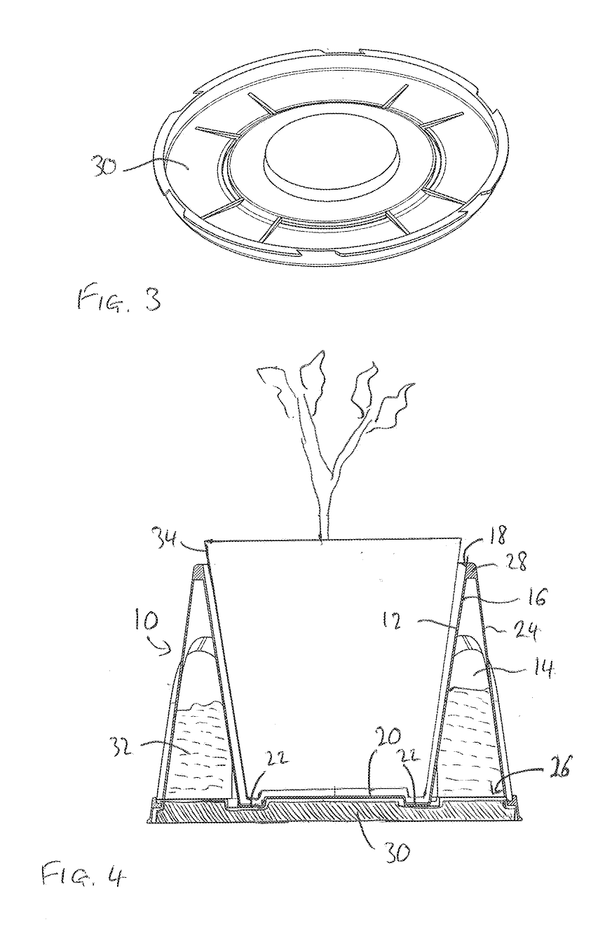

FIG. 3 is a perspective view of a closure for use in the planter;

FIG. 4 corresponds with FIG. 2, showing the planter in use;

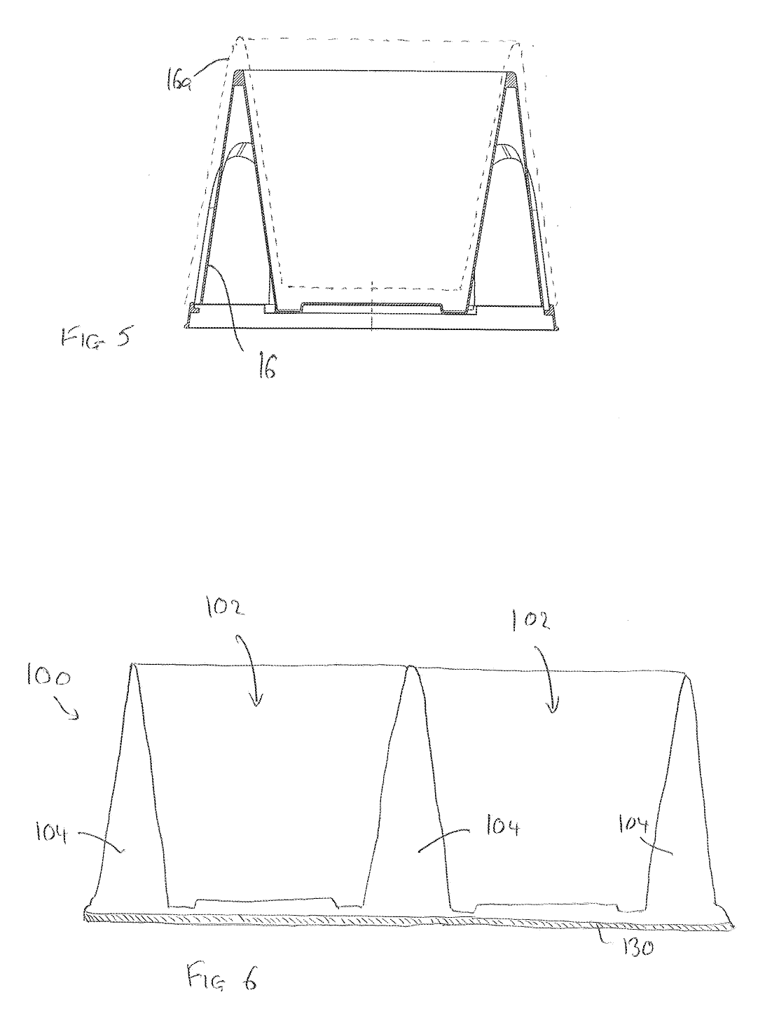

FIG. 5 illustrates how the main part of the planter may be stored, when not in use; and

FIG. 6 corresponds with FIG. 2, showing an alternative embodiment.

Turning to the drawings, and particularly FIG. 1 and FIG. 2, there is shown a planter 10 which defines a planting recess 12 for receiving a plant (not shown in FIG. 1 or FIG. 2), in use, and a ballast cavity 14 for receiving ballast (not shown in FIG. 1 or FIG. 2), in use, to provide stability for the planter 10.

The planter 10 comprises a main part which defines the recess 12 and the cavity 14. The recess 12 has an open, upper mouth 18 (FIG. 1). Below the mouth 18, the recess 12 is bounded by a wall which is continuous in this example and circular in horizontal section and tapers down to the bottom 20 of the recess 12. The recess 12 therefore has an inverted frusto-conical shape, as can be seen from FIG. 2. In one example, the inverted frusto-conical shape of the recess 12 corresponds closely with the shape of a conventional plant pot, for reasons which will be explained below. The bottom 20 may be bounded by a circular channel 22, further increasing the correspondence with the shape of a conventional plant pot.

The ballast cavity 14 can be seen most clearly in FIG. 2. The cavity 14 extends around the perimeter of the planting recess 12, outside the frusto-conical wall of the recess 12. In this example, the cavity 12 extends continuously around the entire perimeter of the recess 12, being bounded on the inside by the wall of the recess 12, and on the outside by a generally non-inverted frusto-conical outer wall 24. The use of an inverted and a non-inverted frusto-conical wall creates a form for the cavity 14 which widens towards its base, at which the cavity has an annular mouth 26. At its upper extremity, the cavity narrows to a circular rim 28 around the mouth 18.

Thus, when the planter 10 is in the orientation illustrated in FIG. 1 and FIG. 2, which is the intended orientation for use, the planting recess 12 will be open from above through the mouth 18 and will widen upwardly toward the mouth 18 from the bottom 20. The cavity 14 surrounds the recess 12, and widens downwardly toward the mouth 26.

The planter 10 further includes a closure 30 in the form of a generally circular disc (FIG. 3). The outer diameter of the closure 30 is complementary in size with the mouth 26. Locking features are provided around the mouth 26 which cooperate with corresponding features around the edge of the closure 30, so that the closure 30 can be releasably fixed in the mouth 26 to close the cavity 14. The features around the mouth 26 and the closure 30 may be interlocking flanges and recesses, screw threads, snap-fit features or other alternatives.

FIG. 4 illustrates a manner in which the planter 10 may be used. In this example, the cavity 14 is wholly or partially filled with ballast material 32. This may be gravel, soil, water or other material. The ballast material 32 can conveniently be introduced by inverting the main part 16, with the closure 30 removed, pouring the ballast material 32 into the inverted cavity 14 and then closing the cavity 14 by fitting the closure 30 into the mouth 26. The planter 10 can then be turned back to the orientation for use (FIG. 1). This results in the planter 10 standing on the ground with the closure 30 against the ground and with the mouth 18 uppermost. Conveniently, the planter 10 may be transported to the location of its intended use without containing ballast material 32, thus making the planter 10 lighter and more convenient to handle, particularly if ballast material 32 can be obtained at the intended location, such as by digging up some soil.

Once the ballast material 32 is in place, a plant pot 34 containing a plant can be placed into the recess 12, through the mouth 18. The planter 10 then snugly supports the plant pot 34. The described form of the cavity 14, together with the weight provided within the cavity 14 by the ballast material 32 cause the plant pot 34 to be stabilised against toppling over. In particular, the base of the planter 10, provided by the closure 30, is significantly wider than the bottom of the plant pot 34, and the body of ballast material 32 serves to lower the centre of gravity of the arrangement of the plant pot 34 and planter 10. This combination of a lowered centre of gravity, and a wider footprint on the ground, is expected to provide significantly greater stability than would be available for the otherwise unsupported plant pot 34. Thus, the risk of the plant pot 34 toppling over is reduced.

The main part 16 is visible when used in the manner described and therefore, the external surface may be decoratively shaped or ornamented. It is also to be noted that the form of the main part 16 is such that the internal boundaries of the recess 12 and the cavity 14 are generally complementary with the outer boundaries of corresponding features, so that a group of main parts 16 can be compactly stacked with each main part 16 nesting with another main part 16 above and below. FIG. 5 illustrates this by showing a main part 16 (without a closure 30) and indicating in broken lines the position of another main part 16a which is nesting from above in the main part 16. This allows a large number of main parts 16 to be compactly stored and transported. Corresponding closures 30 would be stored and transported separately and would be compact because of their planar form.

In another example, illustrated in FIG. 6, a planter 100 provides two planting recesses 102, with an associated ballast cavity 104 and closure 130. The provision of two planting recesses 102 is the principal difference from the first example described above. Other numbers of planting recesses could be provided in other examples.

The main part 16 and the closure 30 may each be formed by moulding, such as by moulding a plastics material. Injection moulding could be used. The cavity 14 has been described as continuous around the circumference of the recess 12, but may be divided or partially obstructed by strengthening ribs, internal strengthening walls or other features if appropriate in view of the required strength, and of the chosen manufacturing materials and techniques.

Many modifications and variations can be made to the apparatus described above, without departing from the scope of the invention. In particular, many different shapes, sizes and relative shapes and sizes could alternatively be chosen. A planter of the type described could be manufactured from many different types of material and by using many different manufacturing techniques. The planter has been described as receiving a plant pot and contents, but alternatively, a plant could be potted directly into the planting recess 12. In that case, the ballast material 32 would still provide the function of improved stability, but the arrangement would be less versatile by making it more difficult to remove and replace the plant with an alternative plant.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-17. (canceled)

18. A planter, comprising:
a planting recess configured to receiving a plant; and
a ballast cavity configured to receiving a ballast that provide stability for the planter.

19. The planter according to claim 18, further comprising a closure configured to retain the ballast in the ballast cavity.

20. The planter according to claim 19, wherein the closure is removable for introducing or removing ballast.

21. The planter according to claim 19, wherein the closure incudes a planar or substantially planar member that forms a base of the planter.

22. The planter according to claim 18, wherein the ballast cavity extends around a perimeter of the planting recess.

23. The planter according to claim 22, wherein the ballast cavity extends continuously around the perimeter of the planting recess.

24. The planter according to claim 18, wherein when the planter is positioned with the planting recess open from above, the ballast cavity widens toward a base of the planter.

25. The planter according to claim 18, wherein when the planter is positioned with the planting recess open from above, the planting recess widens upwardly towards a mouth of the planter.

26. The planter according to claim 18, wherein the planting recess forms an inverted frusto-conical space.

27. The planter according to claim 18, wherein the ballast cavity is provided between the planting recess and an external non-inverted frusto-conical wall.

28. The planter according to claim 18, comprising a continuous wall which divides the planting recess and the ballast cavity.

29. The planter according to claim 18, wherein the planting recess and the ballast cavity are defined by a main part of the planter.

30. The planter according to claim 29, wherein the main part is a moulded part.

31. The planter according to claim 29, wherein the main part is formed to stack, in a nested manner, with another main part of an additional planter when the planting recess and ballast cavity are empty.

32. The planter according to claim 18, further comprising at least one of a plurality of additional planting recesses or a plurality of additional ballast cavities.
